(19) United States
(12) Patent Application Publication
(10) Pub. No.: US 2018/0374331 A1
(43) Pub. Date: Dec. 27, 2018

(54) DEVICE DISPLAYING COGNITIVE FUNCTION LIMITATIONS

(71) Applicant: Honeywell International Inc., Morris Plains, NJ (US)

(72) Inventors: Adam Dewey McBrady, Minneapolis, MN (US); Teresa M. Marta, White Bear Lake, MN (US); Stephan Bork, Murphy, TX (US)

(21) Appl. No.: 15/634,484

(22) Filed: Jun. 27, 2017

(51) Int. Cl. G08B 21/02

(52) U.S. Cl. CPC G08B 21/02; G06F 3/04817

(57) ABSTRACT

Embodiments relate generally to systems and methods for assessing cognitive function limitations. A system may comprise a sensor module, wherein the sensor module comprises a gas detector; and a device, wherein the device is configured to: obtain data from the sensor module, wherein the data comprises environmental data; calculate a cognitive availability value based on the environmental data; and display the cognitive availability value on a user interface of the device.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Knowledge worker and student productivity may be at times limited by environmental factors, such as, for example, indoor air quality. Because humans produce and exhale carbon dioxide (“CO₂”), concentrations of CO₂ in occupied indoor spaces may be higher than concentrations outdoors. Concentrations of CO₂ indoors may range from about 400 parts per million (“ppm”) to about several thousand ppm. There may be a link between advanced cognitive thinking ability and levels of various substances in air, such as, CO₂.

### SUMMARY

In an embodiment, a system for assessing cognitive function limitations may comprise a sensor module, wherein the sensor module comprises a gas detector; a device, wherein the device is configured to: obtain data from the sensor module, wherein the data comprises environmental data (e.g., a carbon dioxide concentration and/or a volatile organic compound and/or volatile organic vapor); calculate a cognitive availability value based on the environmental data; and display the cognitive availability value on a user interface of the device.

In an embodiment, a method for assessing cognitive function limitations may comprise providing a sensor module connected to a device, wherein the sensor module comprises a gas detector; obtaining data, with the device, from the sensor module, wherein the data comprises a carbon dioxide concentration and/or a volatile organic compound or volatile organic vapor; calculating a cognitive availability value based on the carbon dioxide concentration and/or the volatile organic compound and/or volatile organic vapor; and displaying the cognitive availability value on a user interface of the device.

In an embodiment, a method for assessing cognitive function limitations may include providing a sensor module connected to a device, wherein the sensor module comprises a gas detector, a humidity sensor, and a temperature sensor; wherein the device comprises a microphone, a camera, and an ambient light sensor; obtaining data, with the device, from the gas detector, the humidity sensor, the temperature sensor, the microphone, the camera, and the ambient light sensor; allowing a selection of the data with the device; providing selected data with the device; calculating, with the device, a cognitive availability value based on the selected data; and displaying the cognitive availability value on a user interface of the device.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a schematic illustration of a system for obtaining, processing, and/or displaying cognitive limitations in accordance with embodiments of the disclosure.

FIG. 2 is a graph showing an average cognitive score versus CO₂ (ppm) in accordance with embodiments of the disclosure.

FIG. 3 is a graph showing an average cognitive score for various activities/tasks versus CO₂ (ppm) in accordance with embodiments of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

The terms “about” or “approximately” or the like, when used with a number, may mean that specific number, or alternatively, a range in proximity to the specific number, as understood by persons of skill in the art field; and

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

Knowledge workers (e.g., workers/employees whose main capital may be knowledge) and students (e.g., students taking tests, doing homework, performing research, etc.) typically spend a large amount of their time in front of a device (e.g., computer) working (e.g., indoors), and may benefit from knowing an amount of limitations the local environment puts on their advanced thinking ability with a single percentage score/value quantifying the amount their advanced thinking ability may be reduced versus an ideal environment (e.g., cognitive availability value for different levels of carbon dioxide (“CO₂”) and/or volatile organic compounds (“VOC”)). Knowledge workers and students may also benefit from having this score/value displayed on a user interface of a device, so the knowledge users (e.g., workers/students) can take action, such as, for example: (1) moving to another location with better environmental conditions (e.g., a quieter environment) for advanced thinking work; (2) changing local indoor air quality by increasing ventilation and/or air purification; and/or (3) posting (e.g., social media status update post) the amount of limitation on thinking in their local environmental online so other users connected online could use the information to either move to the same place or avoid the place if local conditions are unfavorable. This single percentage score/value quantifying the amount a user's advanced thinking ability may be reduced versus an ideal environment, may be periodically updated in a default setting without any interaction by the user.

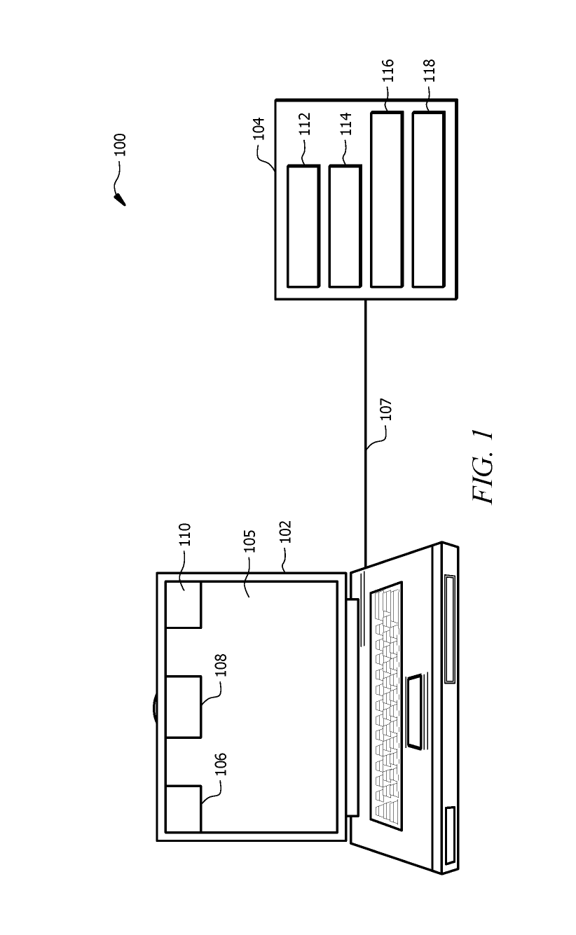

Embodiments of the disclosure may relate to systems and methods for obtaining, combining, and/or processing data (e.g., environmental data/factors/conditions) from a CO₂ sensor, a VOC sensor, a temperature sensor, and/or a humidity sensor located in a dedicated sensor module (e.g., sensor module may be connected to a device via a wired connection such as a universal serial bus (“USB”) or via a wireless connection) with light, motion, and/or noise information that can be derived from the device's microphone, camera, and/or ambient light sensor. Time (e.g., time of day) may also be an environmental factor. That is, environmental data/factors/conditions, such as, for example, time (from a clock of a device), CO₂ levels, VOC levels, temperature, humidity, light, noise/sound, movement of objects and/or movement of people around a user, may be incorporated into a calculation of a cognitive availability value. These environmental factors/conditions may affect a user's performance of a task. In certain embodiments, the sensor module may be embedded into the device. A benefit of the disclosure may be that a user of a device can easily see, on a screen/user interface of the device, a percentage of his/her individual maximum advanced thinking ability that may be available in a local environment, thereby allowing the user to take action to change the environment in order to increase his/her productivity. This disclosure may allow each user to set and/or store different user profiles (e.g., in a device) for weighing different individual environmental sensor inputs (e.g., data from sensors) in calculating a total score/value (e.g., a cognitive availability value for different levels of VOC, CO₂) in order to adjust for individual sensitivity to specific factors. This disclosure may also allow a user to select from a list of preset user profiles (e.g., a user profile only based on CO₂ and/or VOC ignoring other factors, such as, noise or light, a user profile based on all considerations, or a profile that deprioritizes some measurements for a specific user preference (e.g. microphone deprioritized for someone who favors high noise environments), etc.). This may allow a user to view the percentage of his/her cognitive capacity that may be available, in addition to central processing unit (“CPU”) usage, battery life, and/or memory usage that may be available/viewable on the device. Thus, the present disclosure allows for the integration of a CO₂ sensor, a VOC sensor, an ambient light sensor, a temperature sensor, a humidity sensor, a microphone, and/or a camera, as well as, software in high volume computing devices (e.g., device 102 shown on FIG. 1; a second device), such as, for example, computing devices, servers, stationary computers, laptops, smart phones, tablets, intelligent devices which may perform calculations automatically without human interaction, etc.

FIG. 1 is a schematic illustration of system 100 for obtaining, processing, and/or displaying cognitive limitations (e.g., a cognitive availability value) based on environmental factors (e.g., slightly elevated CO₂; VOC levels, noise, light, time, temperature and/or humidity). The system 100 may include a device 102, and a sensor module 104. The device 102 may comprise a user interface 105, a microphone 106, a camera 108, and/or an ambient light sensor 110. The sensor module 104 may comprise a CO₂ sensor 112 (e.g., a gas detector), a VOC sensor 114 (e.g., gas detector), a temperature sensor 116, and/or a humidity sensor 118. In certain embodiments, device 102 and sensor module 104 may each comprise a motion detection and ranging device, and a clock. The device 102 may b e connected to the sensor module 104 via a USB cable 107. Alternatively, the device 102 may be wirelessly connected to the sensor module 104. In certain embodiments, sensor module 104 may be built into device 102. That is, device 102 may comprise sensor module 104. In some embodiments, data may be sent from sensor module 104 to a second device (e.g., a device in the cloud) where computations/calculations may be performed and then results of the calculations may be sent to device 102. In other embodiments, device 102 may perform the calculations locally.

During operation of the system 100, the sensor module 104 may measure CO₂, VOC, temperature, and/or humidity. The sensor module 104 may transmit measurements to the device 102. The device 102 may measure sound/noise with the microphone 106, detect motion with the camera 108 (e.g., moving objects/people around a user working on the device 102 may distract the user from deep thinking); detect the time of day (e.g., a clock); and/or measure light (e.g., intensity, color, duty cycle) with the ambient light sensor 110. Camera 108 may capture images of a user's eye to determine pupil position (e.g., tracking pupil movement). Pupil movement may be correlated with a cognitive availability value. With camera 108 and other sensors, it may be possible to identify the color spectrum and an optimal lighting level that may be identified to reduce eyestrain. A user may take a survey to determine optimal performance hours because the optimal performance hours may vary by chronotype (what defines a person as a “morning person” or an “evening person”).

The device 102 may also monitor a user's typing speed and mouse movement and may utilize this data to adjust weight factors in calculating the cognitive availability value. Device 102 may be capable of monitoring button pushes and finger/hand interactions. Daily interaction with a computer keyboard/mouse can be used to observe and potentially quantify psychomotor impairment. There may be variations among different users with regard to typing speed; therefore, minimizing the variability can be achieved by monitoring speed of typing during consistent periods of word processing, such as repeated keyboard events (e.g., log ins). An existing Cognitive Function Test may allow individuals to self-assess their level of cognitive function in the cognitive domains. A lookup table with various combinations of environmental conditions and associated standardized test scores may assess an individual's cognitive functions.

In certain embodiments, device 102 may store a user's cognitive availability value for previously performed tasks and notify a user of the stored cognitive availability value for a previously performed task. Device 102 may recommend environmental conditions based on the previously stored cognitive availability value. For example, a user may have previously performed a task with certain environmental conditions that resulted in a high cognitive availability value or a low cognitive availability value. Device 102 may store this information including the environmental conditions and the cognitive availability value. Accordingly, while performing a similar task, device 102 may recommend (e.g., via user interface 105), to a user, environmental conditions based on the previously stored cognitive availability value or a user preference, thereby allowing a user to perform a task optimally. Additionally, device 102 may warn (e.g., via user interface 105) a user that the environmental conditions based on the previously stored cognitive availability value are detrimental to the user's performance of the task. A user may select which environmental conditions are incorporated into a calculation of a cognitive availability value based on his/her preference.

The device 102 may also monitor a user's performance for repeating similar work functions (e.g., taking practice tests) and correlate the performance to environmental conditions. That is, the device 102 may determine a user's individual sensitivity to measured environmental factors for a specific cognitive task/activity. The device 102 may obtain/collect these measurements (e.g., data from the sensor module 104 and/or data from the microphone 106, the camera 108, and/or the ambient light sensor 110) and may calculate a cognitive availability value, based on the data, by an algorithm, such as, for example:

Cognitive Availability=1.147-0.0003*(CO₂ parts per million (“ppm”))−0.003*(YOC parts per billion (“ppb”))

Data from the microphone 106, the camera 108, the ambient light sensor 110, the temperature sensor 116, the humidity sensor 118, and/or time, may also be incorporated into an algorithm along with CO₂ and VOC data to provide a cognitive availability value.

It should be noted that data from the microphone 106, the camera 108, the ambient light sensor 110, the temperature sensor 116, and/or the humidity sensor 118 may or may not be selected by a user to be incorporated into an algorithm for calculating cognitive availability. That is, each user may not be affected negatively by, for example, certain light conditions and/or noise (e.g., music), and therefore, may not incorporate data received from the microphone 106 and/or the ambient light sensor 110 into the calculation of the cognitive availability value. That is, each environmental factor/condition may be given a weight (for the calculation of the cognitive availability value) depending on a user's performance and/or preferences. The device 102 may allow a user to set and/or store different user profiles for weighting individual environmental sensor inputs (e.g., sensor data) in the total value/score (e.g., the cognitive availability value) to adjust for an individual sensitivity to specific environmental conditions/factors (e.g., light, noise, etc.). Also, data from an additional sensor may be incorporated into the calculation for the cognitive availability value. That is, an additional sensor may be added to an existing system for this calculation. The device 102 may also allow a user to select from a list of preset user profiles (e.g., user profile only based on CO₂and/or VOC, ignoring other factors such as light, noise, etc.). Ventilation rates may also affect an individual's performance. That is, higher ventilation rates may yield higher performance and lower ventilation rates may yield lower performance.

Table 1 is an example of cognitive availability values for various activities/tasks for different levels of VOC and CO₂ (e.g., cognitive availability values for: Basic Activity Level, Applied Activity Level, Focused Activity Level, Task Orientation Level, Crisis Response Level, Information Seeking Level, Information Usage Level, Breadth of Approach Level, and Strategy Level). The cognitive availability values may be a percentage of maximally obtainable values and may be linearly related to performance of tasks/activities. That is, a higher value may indicate better performance for a task/activity, whereas, a lower value may indicate poorer performance for the task/activity. The data in Table 1 is from Satish, Usha et al., “Is CO₂ an Indoor Pollutant Direct Effects of Low-to-Moderate CO₂ Concentrations on Human Decision-Making Performance.” Environmental Health Perspectives, Vol. 120, No. 12, December 2012, pages 1671-1677; and Allen, Joseph G. et al., “Associations of Cognitive Function Scores with Carbon Dioxide, Ventilation, and Volatile Organic Compound Exposures in Office Workers: A Controlled Exposure Study of Green and Conventional Office Environments.” Environmental Health Perspectives, Vol. 124, No. 6, June 2016, pages 805-812.

TABLE 1
Cognitive availability for various activities/tasks for different levels of VOC and CO₂.

| | | Basic | Applied | Focused | Task | Crisis | Information | Information | Breadth of | |
|---|---|---|---|---|---|---|---|---|---|---|
| | | Activity | Activity | Activity | Orientation | Response | Seeking | Usage | Approach | Strategy |
| | | Level | Level | Level | Level | Level | Level | Level | Level | Level |
| | | (cognitive | (cognitive | (cognitive | (cognitive | (cognitive | (cognitive | (cognitive | (cognitive | (cognitive |
| VOC | CO2 | availability | availability | availability | availability | availability | availability | availability | availability | availability |
| (ppb) | (ppm) | value) | value) | value) | value) | value) | value) | value) | value) | value) |
| | 500 | 1.00 | 1.00 | 1.00 | 1.00 | 1.00 | 1.00 | 1.00 | 1.00 | 1.00 |
| | 1000 | 0.87 | 0.87 | 0.82 | 0.98 | 0.80 | 1.00 | 0.62 | 0.90 | 0.75 |
| | 1500 | 0.75 | 0.75 | 0.65 | 0.95 | 0.60 | 1.00 | 0.25 | 0.75 | 0.23 |
| | 2500 | 0.57 | 0.56 | 0.98 | 0.39 | | 0.97 | 0.25 | 0.27 | 0.05 |
| 10 | | 1.20 | 1.08 | 1.68 | 1.05 | 2.05 | 1.11 | 2.61 | 1.29 | 3.17 |
| 150 | | 1.00 | 1.00 | 1.00 | 1.00 | 1.00 | 1.00 | 1.00 | 1.00 | 1.00 |

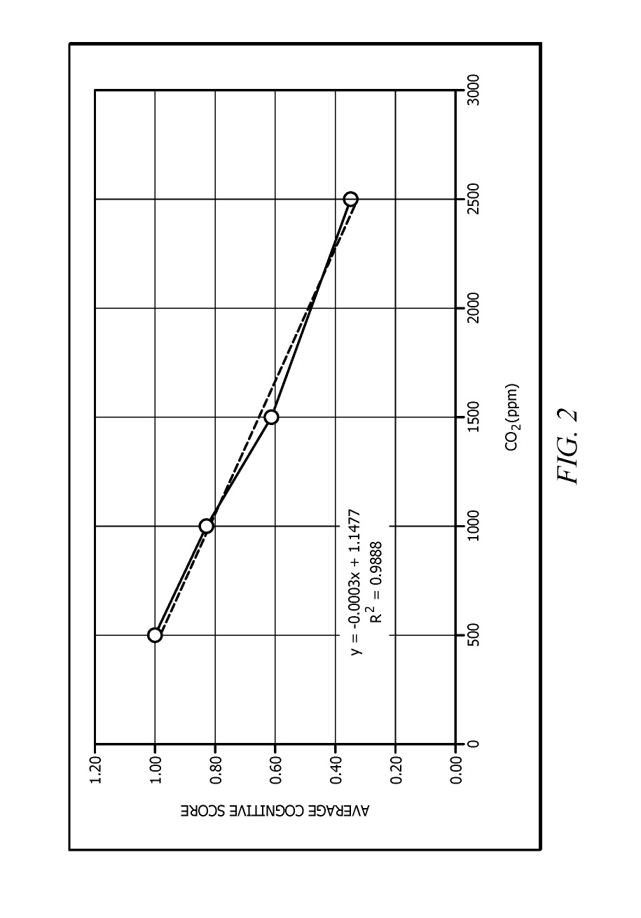

FIG. 2 illustrates average cognitive availability values/scores (“Average Cognitive Score”) versus CO₂ (ppm), based on Table 1. As shown on the graph, the average cognitive availability value decreases as the quantity of CO₂ increases.

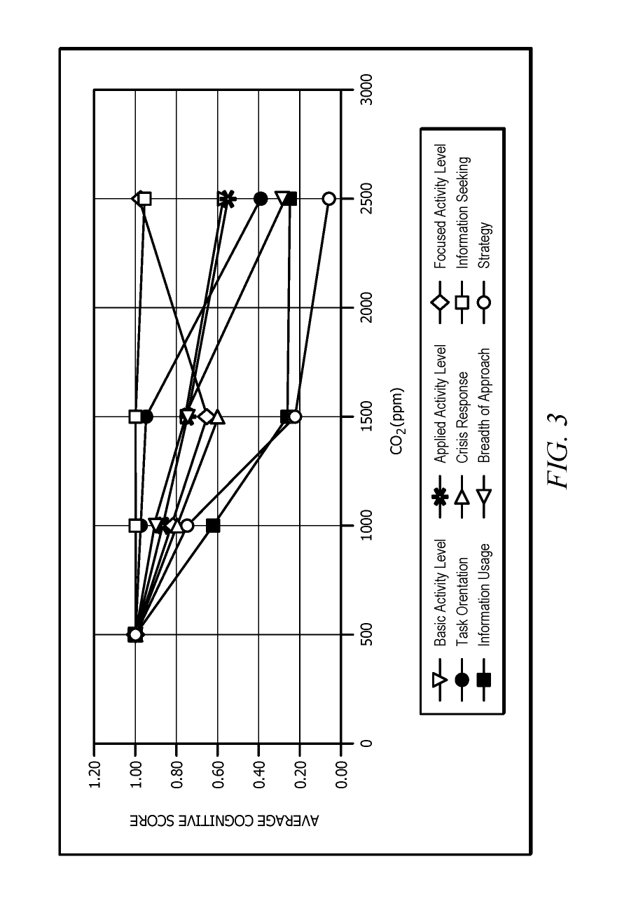

FIG. 3 illustrates average cognitive availability values/scores (“Average Cognitive Score”) for various activities/tasks versus CO₂ (ppm), based on Table 1. As shown on the graph, the average cognitive score/value for many of the various activities/tasks decreases as the CO₂ concentrations rise from 500 ppm to 1500 ppm.

Referring back to FIG. 1, the device 102 may calculate/determine cognitive availability values for different levels of VOC and/or CO₂. A look up table with test score data from users that have completed standardized tests (e.g., SAT) under various environmental/surrounding conditions may be used to calculate a cognitive availability value. Under ideal conditions a group of users may achieve their top SAT scores. As conditions deteriorate, the scores may decrease.

The user interface 105 may display the cognitive availability value, thereby notifying a user of his/her brain's cognitive resources available (e.g., the cognitive function availability). The user interface 105 may also display a user's time spent working and/or an alertness icon based on the cognitive availability value (e.g., a tired face with closed eyes for low alertness may represent a low cognitive availability value; a wide awake face with open eyes for high alertness may represent a high cognitive availability value). Based on the alertness icon and the notification of a user's cognitive resources available, the user may (1) move to another location with better environmental conditions (e.g., a quieter environment) for advanced thinking work; (2) change local indoor air quality by increasing ventilation and/or air purification; (3) post (e.g., social media status update) an amount of limitation on thinking in their local environmental online so other users connected online could use the information to either move to the same place or avoid the place if local conditions are unfavorable.

As noted above, in certain embodiments, data may be transmitted to a second device (e.g., a remote computational device). This data may then be used to calculate a user cognitive ability sensitivity profile which may be transmitted from the second device to users in the field (e.g., device(s) 102).

Systems and methods of the disclosure may be implemented by an information handling system (e.g., device 102, the second device, stationary computing device, etc.). For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer or tablet device, a cellular telephone, a network storage device, or any other suitable device and may vary in size, shape, performance, functionality, and price. The information handling system may include random access memory (“RAM”), one or more processing resources such as a central processing unit (“CPU”) or hardware or software control logic, read-only memory (“ROM”), and/or other types of nonvolatile memory. Additional components of the information handling system may include one or more disk drives, one or more network ports for communication with external devices as well as various input and output (I/O) devices, such as a keyboard, a mouse, and a video display. The information handling system also may include one or more buses operable to transmit communications between the various hardware components.

The information handling system may also include computer-readable media. Computer-readable media may include any instrumentality or aggregation of instrumentalities that may retain data and/or instructions for a period of time. Computer-readable media may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (“EEPROM”), and/or flash memory; as well as communications media such wires, optical fibers, microwaves, radio waves, and other electromagnetic and/or optical carriers; and/or any combination of the foregoing.

Having described various systems and methods, various embodiments can include, but are not limited to:

In a first embodiment, a system for assessing cognitive function limitations may comprise a sensor module; and a device, wherein the device is configured to: obtain data from the sensor module, wherein the data comprises environmental data; calculate a cognitive availability value based on the environmental data; and display the cognitive availability value on a user interface of the device.

A second embodiment may include the system of the first embodiment, wherein the sensor module and the device comprise a plurality of sensors comprising a gas detector, a clock, a humidity sensor, a temperature sensor, a microphone, a camera, a motion detector, and an ambient light sensor.

A third embodiment may include the system of the first or second embodiment, wherein the data comprises temperature data, humidity data, and/or time.

A fourth embodiment may include the system of any of the preceding embodiments, wherein the data further comprises microphone data, camera data, motion detector data, and/or ambient light sensor data.

A fifth embodiment may include the system of any of the preceding embodiments, wherein the ambient light sensor is configured to measure intensity and/or color of light.

A sixth embodiment may include the system of any of the preceding embodiments, wherein the device is further configured to display, in the user interface, an alertness icon based on the cognitive availability value.

A seventh embodiment may include the system of any of the preceding embodiments, wherein the sensor module is connected to the device by a universal serial bus cable or the sensor module is embedded into the device.

An eighth embodiment may include the system of any of the preceding embodiments, wherein the device is further configured to allow weighting (e.g., assigning a weight to each of the different types of data) the data from each of the sensors, for a calculation of the cognitive availability value.

A ninth embodiment may include the system of any of the preceding embodiments, wherein the device is further configured to adjust a weight for the data from each of the sensors, for the calculation of the cognitive availability value.

A tenth embodiment may include the system of any of the preceding embodiments, wherein the device is further configured to allow storing of a cognitive availability value for a previously performed task and to provide a recommendation for environmental conditions based on a stored cognitive availability value for the previously performed task.

In an eleventh embodiment, a method for assessing cognitive function limitations may comprise providing a sensor module connected to a device; obtaining sensor data, with the device, from the sensor module, wherein the sensor data comprises environmental data; calculating, with the device or a second device, a cognitive availability value based on the environmental data; and displaying the cognitive availability value on a user interface of the device.

A twelfth embodiment may include the method of the eleventh embodiment, further comprising allowing, with the device, weighting the sensor data for a calculation of the cognitive availability value; wherein the sensor data is from a plurality of sensors comprising a gas detector, a clock, a humidity sensor, a temperature sensor, a microphone, a camera, a motion detector, a clock, and an ambient light sensor.

A thirteenth embodiment may include the method of the eleventh or twelfth embodiments, further comprising adjusting a weight of the sensor data based on a preference or a cognitive availability value of a previously performed task.

A fourteenth embodiment may include the method of any one of the eleventh through thirteenth embodiments, further comprising recommending, with the device, environmental conditions based on the preference or the cognitive availability value of the previously performed task.

In a fifteenth embodiment, a method for assessing cognitive function limitations may include providing a sensor module connected to a device; obtaining data, with the device; allowing a selection of the data, with the device, based on a preference or a previously calculated cognitive availability value for a previously performed task; calculating a cognitive availability value based on the selection of the data; and displaying the cognitive availability value on a user interface of the device.

A sixteenth embodiment may include the method of the fifteenth embodiment, further comprising further comprising allowing, with the device, weighting of the data from each of a gas detector, a clock, a humidity sensor, a temperature sensor, a microphone, a camera, a motion detector, a clock, and an ambient light sensor.

A seventeenth embodiment may include the method of the fifteenth or sixteenth embodiment, further allowing, with the device, an addition of data from an additional sensor for a cognitive availability value calculation.

An eighteenth embodiment may include the method of the fifteenth through seventeenth embodiments, further comprising allowing, with the device, adjustment of a weight of the data for a calculation of the cognitive availability value.

A nineteenth embodiment may include the method of any one of the fifteenth through eighteenth embodiments, further comprising displaying, in the user interface, an alertness icon based on the cognitive availability value.

A twentieth embodiment may include the method of any one of the fifteenth through nineteenth embodiments, further comprising allowing storage of a profile (e.g., a user profile), wherein the profile comprises weighted data.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow that scope including all equivalents of the subject matter of the claims. Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as “comprises,” “includes,” and “having” should be understood to provide support for narrower terms such as “consisting of,” “consisting essentially of,” and “comprised substantially of.” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

1. A system for assessing cognitive function limitations, the system comprising:
a sensor module; and
a computing device, comprising a processor;
wherein the sensor module is configured to detect a plurality of different types of data for a surrounding environment associated with a user of the computing device and transmit the data to the computing, device, and the computing device is configured to:
obtain the data from the sensor module, wherein the data for the surrounding environment comprises environmental data relating to a plurality of factors affecting cognitive availability:
calculate a total cognitive availability value based on the environmental data, wherein using the data relating to each factor, a cognitive availability value is generated for each factor, wherein the total cognitive availability factor is each factor, and wherein the total cognitive availability value is a single value indicative of effects of the plurality of factors on the user's cognitive availability; and
display the cognitive availability value to the user on a user interface of the device.

2. The system of claim 1, wherein the sensor module and the device comprise a plurality of sensors comprising a gas detector, a clock, a humidity sensor, a temperature sensor, a microphone, a camera, a motion detector, and an ambient light sensor; and wherein the processor uses the data from each of the plurality of sensors to calculate the cognitive availability value for the factor associated with each sensor.

3. The system of claim 2, wherein the data comprises temperature data, humidity data, and time.

4. The system of claim 3, wherein the data further comprises microphone data, camera data, motion detector data, and ambient light sensor data, and wherein the camera data comprises data indicative of the user's pupil position.

5. The system of claim 4, wherein the ambient light sensor is configured to measure intensity and/or color of light.

6. The system of claim 4, wherein the device is further configured to display, in the user interface, an alertness icon based on the cognitive availability value.

7. The system of claim 1, wherein the sensor module is connected to the device by a universal serial bus cable or wherein the sensor module is embedded within the device.

8. The system of claim 1, wherein, when availability value, the device weighs each cognitive availability value relating to one of the plurality of factors.

9. The system of claim 8, wherein the device is further configured to store a user profile indicative of an amount for weighing of each of the plurality of factors based on individual user sensitivity to the plurality of factors and to adjust weighing of each cognitive availability value relating to one of the plurality of factors accordingly.

10. The system of claim 9, wherein the device is further configured to allow storing of a cognitive availability value for a previously performed task and to provide a recommendation for environmental conditions based on the stored cognitive availability value for the previously performed task.

11. A method for assessing cognitive function limitations, the method comprising:
providing a sensor module connected to a computing device:
obtaining sensor data for a surrounding environment associated with a user, with the device, from the sensor module, wherein the sensor data for the surrounding environment comprises environmental data relating to a plurality of factors affecting cognitive availability;
calculating a total cognitive availability value based on the environmental data, wherein using the data relating to each factor, a cognitive availability value is generated for each factor, wherein the total cognitive availability value is generated by combining all of the cognitive availability values relating to each factor, and wherein the total cognitive availability value is a single value indicative of effects of die plurality of factors on cognitive availability; and
displaying the cognitive availability value to the user on a user interface of the device.

12. The method of claim 11, further comprising allowing, with the device, weighting each cognitive availability value relating to one of the plurality of factors for a calculation of the total cognitive availability value; wherein the sensor data is from a plurality of sensors comprising a gas detector, a clock, a humidity sensor, a temperature sensor, a microphone, a camera, a motion detector, a clock, and an ambient light sensor.

13. The method of claim 12, further comprising adjusting the weighting of each cognitive availability value relating to one of the plurality based on a preference or a cognitive availability value of a previously performed task.

14. The method of claim 13, further comprising recommending, with the device, environmental conditions based on the preference or the cognitive availability value of the previously performed task.

15. A method for assessing cognitive function limitations, the method comprising:
providing a sensor module connected to a device;
obtaining data for a surrounding environment associated with a user with the device;
allowing a selection of the data for the surrounding environment relating to a plurality of factors affecting cognitive availability, with the device, based on a preference or a previously calculated cognitive availability value for a previously performed task;
calculating a cognitive availability value based on the selection of the data, wherein the cognitive availability value is a single value indicative of an amount of reduction of the user's cognitive availability in the surrounding environment versus the user's cognitive availability in an ideal environment, accounting for the plurality of factors; and
displaying the cognitive availability value to the user on a user interface of the device.

16. The method of claim 15, further comprising allowing, with the device, weighting of the data from each of a gas detector, a clock, a humidity sensor, a temperature sensor, a microphone, a camera, a motion detector, a clock, and an ambient light sensor.

17. The method of claim 16, further allowing, with the device, an addition of data from an additional sensor for a cognitive availability value calculation.

18. The method of claim 17, further comprising allowing, with the device, adjustment of a weight of the data for a calculation of the cognitive availability value.

19. The method of claim 15, further comprising displaying, in the user interface, an alertness icon based on the cognitive availability value.

20. The method of claim 15, farther comprising allowing storage of a profile, wherein the profile comprises weighted data.
